(19) United States
(12) Patent Application Publication
(10) Pub. No.: US 2004/0208015 A1
(43) Pub. Date: Oct. 21, 2004

(54) VEHICLE MIRROR WITH INTERNAL ILLUMINATION SOURCE AND TRANSMITTING HOUSING

(75) Inventors: Ian Boddy, Ada, MI (US); Keith D. Foote, Kentwood, MI (US); Volker Christian Rudinitzki, Grand Rapids, MI (US)

Correspondence Address: MCGARRY BAIR PC, 171 MONROE AVENUE, N.W., SUITE 600, GRAND RAPIDS, MI, 49503, US

(73) Assignee: Magna Donnelly Mirrors North America, L.L.C., Kentwood, MI (US)

(21) Appl. No.: 10/605,509

(22) Filed: Oct. 3, 2003

Related U.S. Application Data
(60) Provisional application No. 60/319,595, filed on Oct. 3, 2002.

(51) Int. Cl. B60Q 1/26

(52) U.S. Cl. 362/494

(57) ABSTRACT

The invention relates to an external rear-view mirror with a mirror housing having a light source capable of illuminating various portions of a vehicle and the surrounding area depending upon the operational status of the vehicle. The mirror housing is transparent or translucent to enable the light source to illuminate through the housing.

### CROSS REFERENCE TO RELATED APPLICATIONS

This application claims the benefit of U.S. provisional application Serial No. 60/319,595, filed Oct. 3, 2002, which is incorporated herein in its entirety.

### BACKGROUND OF INVENTION

1. Field of the Invention

The invention relates to an external vehicle mirror and, more particularly, to an external vehicle mirror having an internal illumination source and a housing capable of transmitting illumination from the internal source to the exterior.

2. Description of the Related Art

External mirrors are ubiquitous for contemporary vehicles. External mirrors have long been used to aid the driver in operating the vehicle, especially in improving the rearward view of the driver. Over time, more and more functionality has been incorporated into the external mirrors. For example, it is common to pivot or fold the external mirror against the vehicle body and prevent the jarring of the mirror when the vehicle is not operated. The mirror-folding function can incorporate a power assist, such as that disclosed in U.S. Pat. No. 5,684,646, which is incorporated by reference.

Functionality is also being added by incorporating lights for illuminating portions of the vehicle or the surrounding area into external mirrors. These lights have been used for several different illumination modes. One mode of illumination is a downwardly directed light source that illuminates a portion of the vehicle, generally one of the front door areas, adjacent the external mirror. This type of downwardly directed light source is often referred to as a “puddle light.” Another illumination mode is accomplished by a rearwardly directed light, which illuminates the portion of the vehicle behind the mirrors and is useful in reverse operation of the vehicle. This mode of illumination is often referred to as a “rear assist light.” An additional illumination mode comprises light sources incorporated into the external mirror to perform a turn signal indicator function, referred to as a “turning mode.”

Since many of the illumination modes are very useful and convenient to the vehicle operator, it is desirable to incorporate as many illumination modes in an external mirror as possible. Unfortunately, several characteristics of the external mirror and the vehicle marketplace make it difficult to incorporate these illumination modes in a single external mirror.

External mirror assemblies are typically constructed to minimize their cross-sectional profile to reduce aerodynamic drag, which can improve vehicle fuel efficiency and reduce the associated wind-generated noise of the mirror. The tendency to reduce or minimize the cross-sectional profile of the mirror results in little available interior volume in the mirror system for locating the light assemblies needed for illumination modes. To the extent that interior volume is available for mounting the light source, the location of the available interior volume is not always at a location where the light source can illuminate the desired area. The undesirable location of available interior volume is exacerbated when multiple modes of illumination are desired.

The characteristics of the vehicle parts manufacturing marketplace in general and the exterior mirrors specifically places additional constraints and hurdles for providing a suitable multiple illumination mode external mirror. The exterior mirror marketplace has conflicting characteristics: increased functionality, reduced cost, and reduced part count. Reduced part count for the most part is related to cost. Thus, while there is a desire for these illumination modes, they typically must be accomplished with minimal cost increases and part count increases.

### SUMMARY OF INVENTION

In one aspect, the invention relates to a vehicular mirror system comprising: a mirror housing enclosing a mounting bracket having a proximal end and a distal end and adapted to be mounted to a vehicle; an outwardly-facing reflective element; a tilt actuator assembly provided with the mounting bracket and mounting the reflective element and comprising an actuator for adjusting the position of the reflective element; a light source mounted within the mirror housing; and wherein the mirror housing is translucent to transmit light from the light source to the exterior of the mirror housing.

In another aspect, the invention relates to a combination motor vehicle and vehicular mirror system comprising: a motor vehicle adapted for mounting the vehicular mirror system thereto; a mirror housing enclosing a mounting bracket having a proximal end and a distal end and adapted to be mounted to a vehicle; an outwardly-facing reflective element; a tilt actuator assembly provided with the mounting bracket and mounting the reflective element and comprising an actuator for adjusting the position of the reflective element; a light source mounted within the mirror housing; and wherein the mirror housing is translucent to transmit light from the light source to the exterior of the mirror housing.

Various embodiments of the invention are also contemplated. For example, the light source can comprise at least one incandescent light bulb. The light source can comprise at least one light emitting diode. The light source can be mounted to the mounting bracket. The light source can be mounted to the actuator. The mirror housing can comprise at least one optic region having different light transmission properties than the remainder of the mirror housing.

A light pipe can be provided for directing the light from the light source to the at least one optic region. A reflective element carrier can be provided for supporting the reflective element, wherein the reflective element carrier can comprise an area having a reflective surface adapted to reflect light from the light source.

The reflective surface can be also adapted to transmit a portion of the light from the light source. The area having the reflective surface can be adapted to reflect 90% of the light from the light source and transmit 10% of the light from the light source.

The light source can comprise a directional light element adapted to focus light in a preselected direction. The directional light element can be mounted to the distal end of the mounting bracket.

### BRIEF DESCRIPTION OF DRAWINGS

FIG. 1 is a front perspective view of an external mirror system according to the invention including a transparent or translucent mirror housing rotatably mounted to a mirror support, which is adapted to be connected to a vehicle and an illumination source mounted inside the housing.

FIG. 2 is a side elevational view of the external mirror system of FIG. 1.

FIG. 3 is an exploded view of the external mirror system of FIG. 1 and illustrates the major components including the mirror housing, the mirror support, a pedestal motor housing, an illumination source, and a mirror system.

FIG. 4 is a front perspective view similar to FIG. 1, but showing an alternative embodiment of an external mirror system according to the invention.

FIG. 5 is a side elevational view of the external mirror system of FIG. 4.

FIG. 6 is a front perspective view similar to FIGS. 1 and 4, but showing a third embodiment of an external mirror system according to the invention.

FIG. 7 is a side elevational view of the external mirror system of FIG. 6.

FIG. 8 is a front perspective view similar to FIGS. 1, 4 and 6, but showing a fourth embodiment of an external mirror system according to the invention.

FIG. 9 is a side elevational view of the external mirror system of FIG. 8.

FIG. 10 is a front perspective view similar to FIGS. 1, 4, 6 and 8, but showing a fifth embodiment of an external mirror system according to the invention.

FIG. 11 is a side elevational view of the external mirror system of FIG. 10.

FIG. 12 is a rear perspective view of the fifth embodiment illustrated in FIGS. 10 and 11.

FIG. 13 is a front perspective view similar to FIGS. 1, 4, 6, 8 and 10, but showing a sixth embodiment of an external mirror system according to the invention.

FIG. 14 is a side elevational view of the external mirror system of FIG. 13.

### DETAILED DESCRIPTION

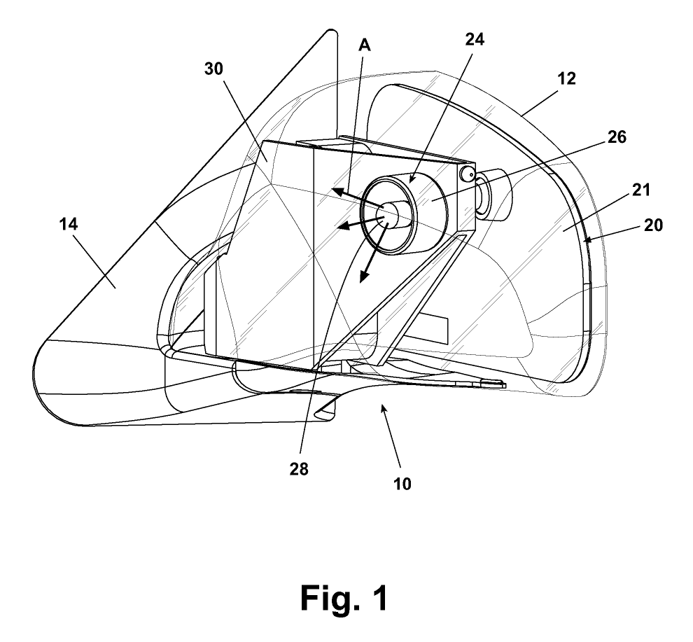

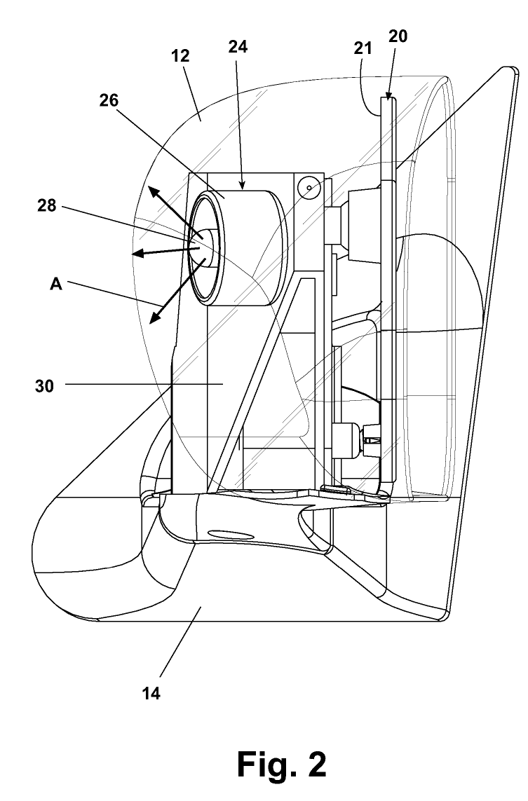

FIGS. 1-3 illustrate an external mirror system 10 of the type suitable for mounting to the exterior of a vehicle (not shown). The external mirror system 10 is a generally conventional shape comprising a mirror housing 12 pivotally mounted to a mirror support 14, which is adapted to be mounted to a vehicle. The mirror housing 12 is closed on a forward side and defines a recess 16 on its rear side in which is received a tilt actuator assembly 18, a reflective element carrier 20, and a reflective element or mirror 22 mounted to a rearward-facing surface of the reflective element carrier 20. The reflective element carrier 20 comprises a forward facing surface 21 in opposed juxtaposition to the reflective element 22. The external mirror system 10 is mounted to a vehicle (not shown) in a conventional manner, and is connected in a generally conventional manner to a remote control pad (not shown) inside the vehicle through a control cable (not shown). In accordance with the invention, the mirror housing 12 is not completely opaque. In other words, the housing 12 has all or at least a portion thereof that is transparent or translucent, i.e., capable of transmitting light from an illumination source that originates from within the housing. In the embodiment of FIGS. 1-3, the entire housing 12 is transparent or translucent.

A light assembly 24 is mounted within the mirror housing 12 and comprises a reflector 26 in which is mounted a light element 28. The light element 28 is preferably an incandescent lamp. However, other suitable light sources, such as a light-emitting diode, can also be used. It will be apparent that when the light element 28 is illuminating, as shown by the arrows A, the light will be visible from the exterior of the housing 12 because the housing transmits the light.

The tilt actuator assembly 18 comprises an actuator 51, having a bracket 30, a motor 32, a high-speed actuator spindle 34, a low-speed actuator spindle 36, and operably interconnected clutch, gears and spindles. The bracket 30 comprises a proximate end adapted for pivotable mounting to the mirror support 14, and a distal end adapted for attachment of the reflective element carrier 20. The motor 32, the actuator spindles 34, 36, and the clutch, gears and spindles are enclosed within a tilt actuator receptacle 38 in the bracket 30. These components can alternatively be mounted into a receptacle molded directly into the housing 12, or another structure capable of securing each component in operable interconnection for operation of the external mirror system 10.

The motor 32 is preferably a generally conventional variable-speed 12-volt DC electric motor having sufficient power for operation of the mirror system 10. In a preferred embodiment, the motor 32 is connected to the vehicle electrical system through a conventional controller (not shown) that can provide electrical power in selected voltages for operating the motor 32 at correspondingly selected speeds. For example, such a controller can selectively switch between either of two circuits, a first circuit for low speed operation and a second circuit for high-speed operation, providing current to the motor 32. The voltage in the low speed circuit can be selectively reduced by inserting a resistor in the low speed circuit in series between the power supply and the motor 32; the reduced voltage results in the lower angular velocity of the motor 32.

A plate-like cover plate 40 is adapted to seal the tilt actuator receptacle 38 and is provided with a high-speed actuator spindle aperture 42 and a low-speed actuator spindle aperture 44 for insertion of the high-speed actuator spindle 34 and the low-speed actuator spindle 36, respectively, therethrough. The cover plate 40 is mounted to the bracket 30 using suitable fasteners, such as screws, or a snap-fit assembly, with an appropriate weather-tight seal, such as a cover gasket, thereby forming a weather-tight enclosure for the motor 32 and operable components of the tilt actuator assembly 18.

The bracket 30 comprises an irregularly shaped body having a reflective element carrier pivot mount 46 at a distal end, a pivot post chamber 48 at a proximal end, and the tilt actuator receptacle 38 intermediate the distal and proximal ends. A well-known anti-rotation assembly (not shown) is also provided to prevent rotation of the reflective element carrier 20 about an axis extending through the reflective element carrier pivot mount 46 orthogonal to the plane of the reflective element carrier 20 while allowing vertical and horizontal tilting of the reflective element carrier 20 as herein described. The pivot post chamber 48 at a lower portion thereof terminates in a bottom wall having a plurality of ratchet tooth slots (not shown), preferably numbering three.

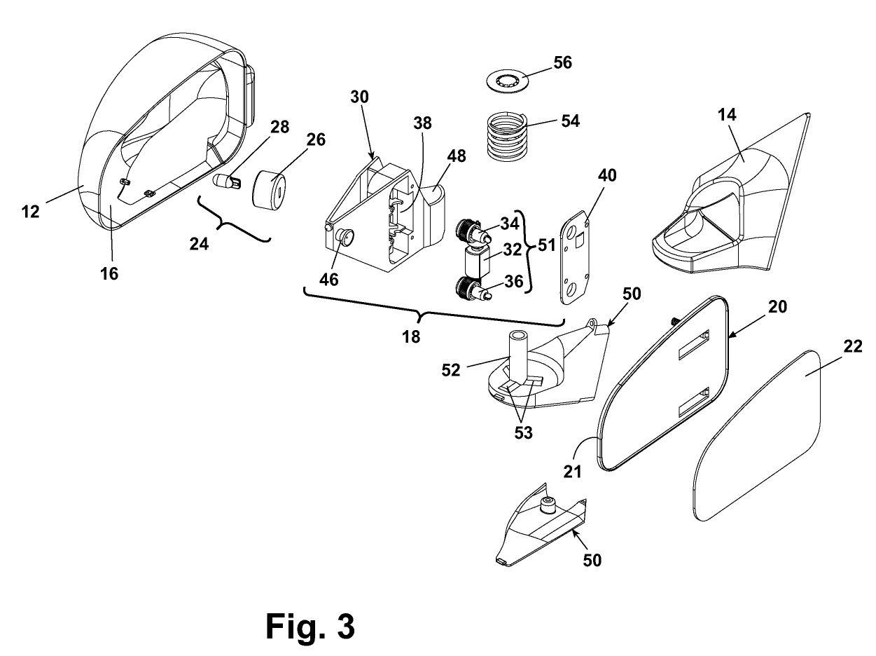

A pivot post bracket 50 is an irregularly-shaped body comprising a pivot post 52 and a plurality of ratchet teeth 53, shown in FIG. 3 as numbering three. The pivot post 52 is adapted to be inserted into the pivot post chamber 48 for pivotable rotation of the bracket 18 relative to the pivot post bracket 50. A spring 54 is inserted into the pivot post chamber 48 over the pivot post 52 and retained around the pivot post 52 by a washer-like retainer 56 inserted over the pivot post 52 and frictionally retained thereon, similar to a compression nut mechanism. The bracket 30 can be pivoted relative to the pivot post bracket 50 with the engagement of the ratchet teeth 53 in the ratchet tooth slots retaining the bracket 30 in selected positions. Compression of the spring 54 will occur during translation of the ratchet teeth 53 relative to the ratchet tooth slots, and will tend to retain the ratchet teeth 53 in the ratchet tooth slots in the absence of any pivotal force on the bracket 30.

The reflector 26 can be a separate item mounted to the bracket 30, or it can be formed integrally with the bracket 30, as by molding. Similarly, the light element 28 can be received in a socket in the reflector 26 or in a socket in the bracket 30. Also, more than one light assembly 24 can be placed within the housing, depending upon the desired function. For example, one light assembly can be mounted facing forward as shown, and another can be mounted facing downward as a puddle light (not shown). The light elements can be a predetermined color to indicate function, e.g., white for a puddle or security light, and amber for a turn signal. In any event, the light element 28 will be electrically connected to a power source, such as the actuator 51, and can be illuminated manually, or automatically in response to an external signal. For example, the light element 28 can illuminate only when turning in a given direction, or it can illuminate only when the vehicle headlights are on.

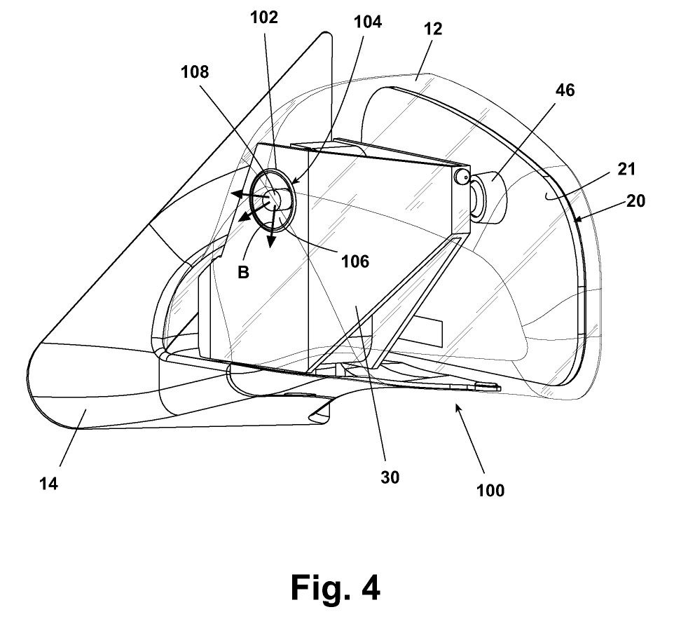

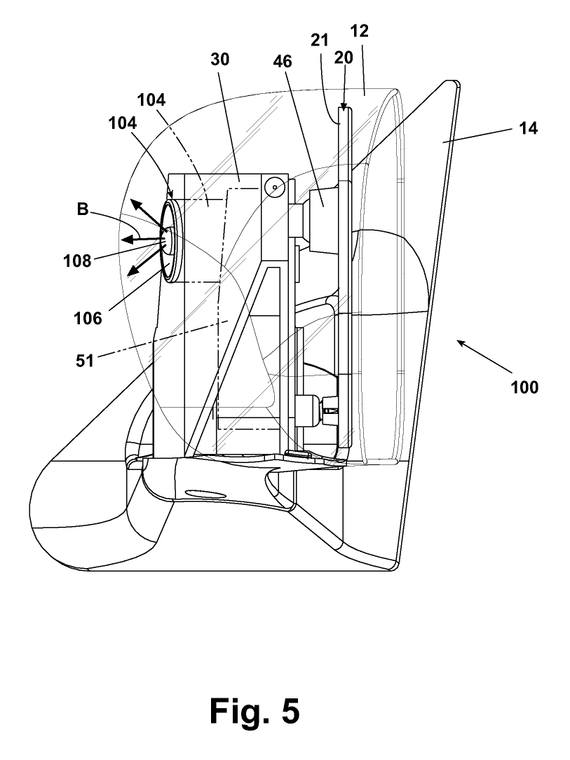

A second embodiment of an external mirror system 100 according to the invention is shown in FIGS. 4 and 5. In this and all other embodiments identified herein, like numerals will be used to reference like parts. In this embodiment, the transparent or translucent housing 12 encompasses the bracket 30, and the reflective element carrier 20 mounted thereto, which is pivotable about the pivot mount 46. The housing 12 and the bracket 30 are mounted for rotation to the mirror support 14. The bracket 30 has a forward facing aperture 102 disposed adjacent to the actuator 51. A light assembly 104 comprises a reflector 106 and a light element 108. The light element 108 is mounted directly to the actuator 51 in registry with the aperture 102. The reflector 106 can also be a separate item mounted to the actuator 51 or formed integrally with the actuator 51, and a portion of the reflector 106 can extend through the aperture 102. The light element 108 is preferably an incandescent lamp. However, other suitable light sources, such as a light-emitting diode, can also be used. It will be apparent that when the light element 108 is illuminating, as shown by the arrows B, the light will be visible from the exterior of the housing 12 because the housing transmits the light.

The reflector 106 can also be a separate item mounted to the bracket 30, or formed integrally with the bracket, as by molding. Also, more than one light assembly 104 can be placed within the housing 12, depending upon the desired function. For example, one light assembly can be mounted facing forward as shown, and another can be mounted facing downward as a puddle light (not shown). The light elements can be a predetermined color to indicate function, e.g., white for a puddle light, and amber for a turn signal. In any event, the light element 108 will be electrically connected to a power source, typically the actuator 51 to which it is mounted, and can be illuminated manually, or automatically in response to an external signal. For example, the light element 108 can illuminate only when turning in a given direction, or it can illuminate only when the vehicle headlights are on.

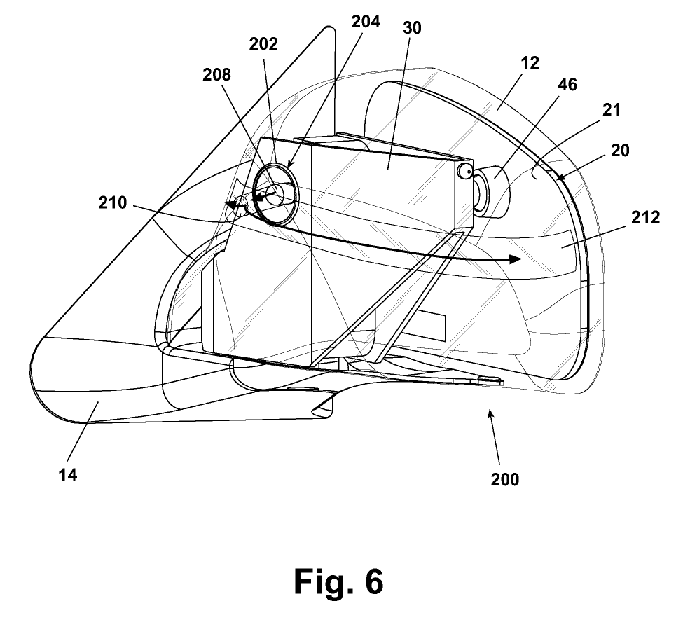

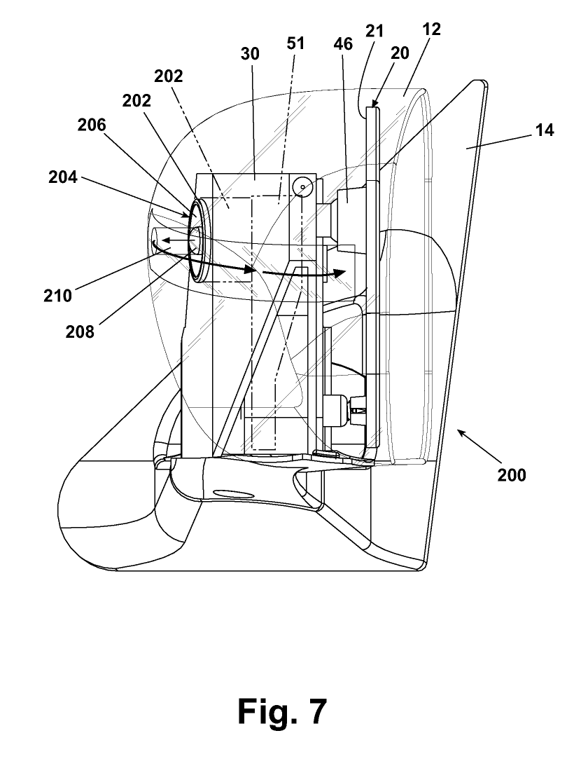

A third embodiment of an external mirror system 200 according to the invention is shown in FIGS. 6 and 7. In this embodiment, the transparent or translucent housing 12 encompasses the bracket 30, and the reflective element carrier 20 mounted thereto, which is pivotable about the pivot mount 46. The housing 12 and the bracket 30 are mounted for rotation to the mirror support 14. The bracket 30 has a forward facing aperture 202 disposed adjacent to the actuator 51. A light assembly 204 comprises a reflector 206 and a light element 208 mounted directly to the actuator 51 in registry with the aperture 202. A portion of the reflector 206 can extend through the aperture 202. The light element 208 is preferably an incandescent lamp. However, other suitable light sources, such as a light-emitting diode can also be used.

A well-known light pipe 210 extends from the light element 208 to the surface of the housing 12, where it communicates with an optical zone 212 on the housing 12. The light pipe 210 is adapted to direct light from the light element 208 to the optical zone 212. Light from the light element 208 is also directed to other areas of the housing 12 as with the embodiments shown in FIGS. 1-5. The optical zone 212 has different refraction or transmissibility properties than the remainder of the housing 12. Light from the light element 208 that is directed to the optical zone 212 will appear different, e.g. having a different intensity, than light coming from the light element 208 that may be diffused to other areas of the housing 12.

The reflector 206 can be a separate item mounted to the bracket 30, or formed integrally with the bracket, as by molding. Or it can be a separate item mounted to the actuator 51 or formed integrally with the actuator 51. Similarly, the light element 208 can be received in a socket in the reflector 206 or in a socket in the actuator 51. Also, more than one light assembly 204 can be placed within the housing, depending upon the desired function. For example, one light assembly can be mounted facing forward as shown, and another can be mounted facing downward as a puddle light (not shown). The light elements can be a predetermined color to indicate function, e.g., white for a puddle light, and amber for a turn signal. In any event, the light element 208 will be electrically connected to a power source, typically the actuator 51 to which it is mounted, and can be illuminated manually, or automatically in response to an external signal. For example, the light element 208 can illuminate only when turning in a given direction, or it can illuminate only when the vehicle headlights are on.

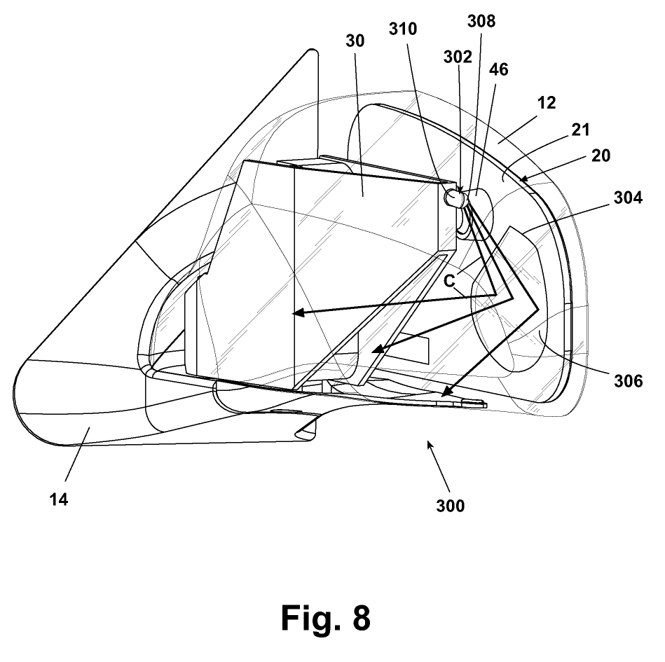

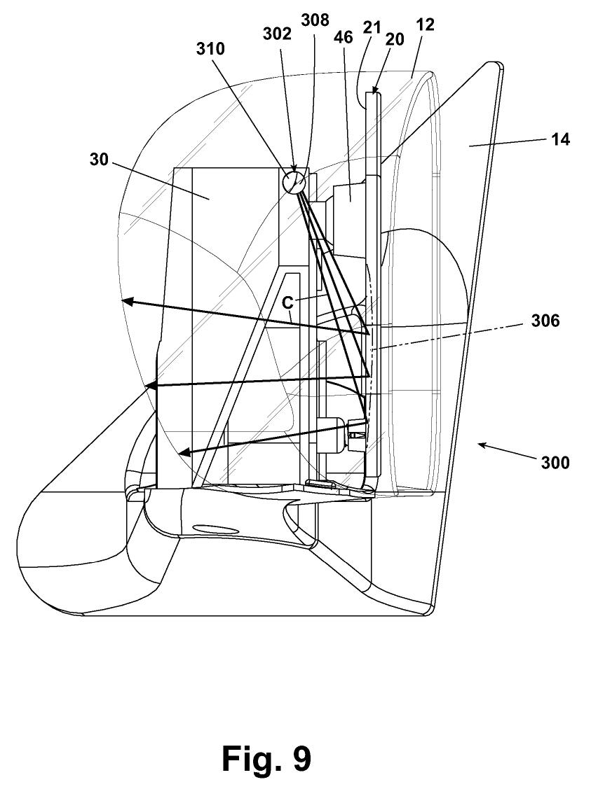

A fourth embodiment of an external mirror system 300 according to the invention is shown in FIGS. 8 and 9. In this embodiment, the transparent or translucent housing 12 encompasses the bracket 30, and the reflective element carrier 20 mounted thereto, which is pivotable about the pivot mount 46. The housing 12 and the bracket 30 are mounted for rotation to the mirror support 14. A directional light element 302 capable of focusing light in a preselected direction is mounted to the end of the bracket 30. The light element 308 is directional in the sense that light emanating from the element is blocked by a shield or mask 310 on or adjacent to the element 308.

The forward-facing surface 21 of the reflective element carrier 20 comprises a defined region 304 having a reflective surface 306 inside the region. The region 304 can comprise a cut-out in the reflective element carrier 20 with a reflective film covering the region to define the reflective surface 306, or it can comprise a reflective material disposed in the region 304 on the forward-facing surface 21. Alternatively, the reflective surface 306 can comprise a reflective coating on the back of the reflective element 22.

The light element 308 is preferably an incandescent lamp. However, other suitable light sources, such as a light-emitting diode or a light pipe extending from inside the bracket 30, can also be used. The shield 310 is disposed so that light is directed along the arrows C toward the reflective surface 306, where it is reflected back through the housing 12.

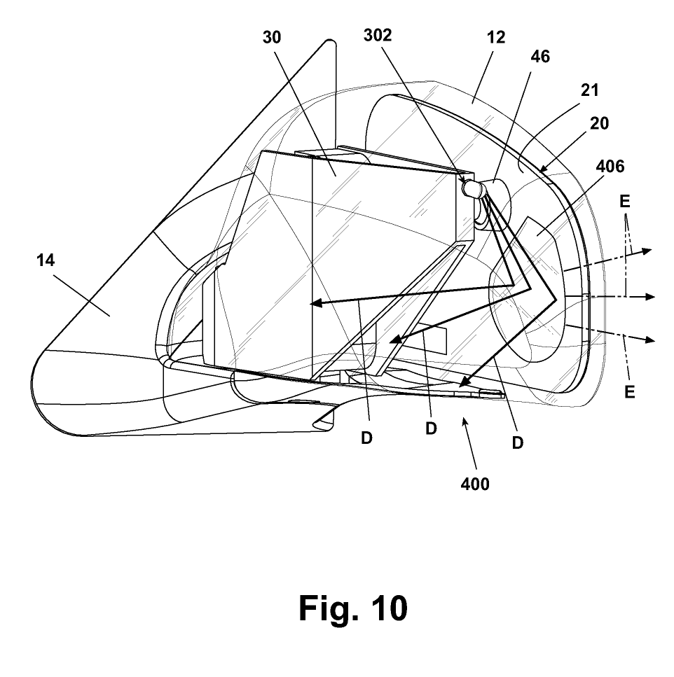

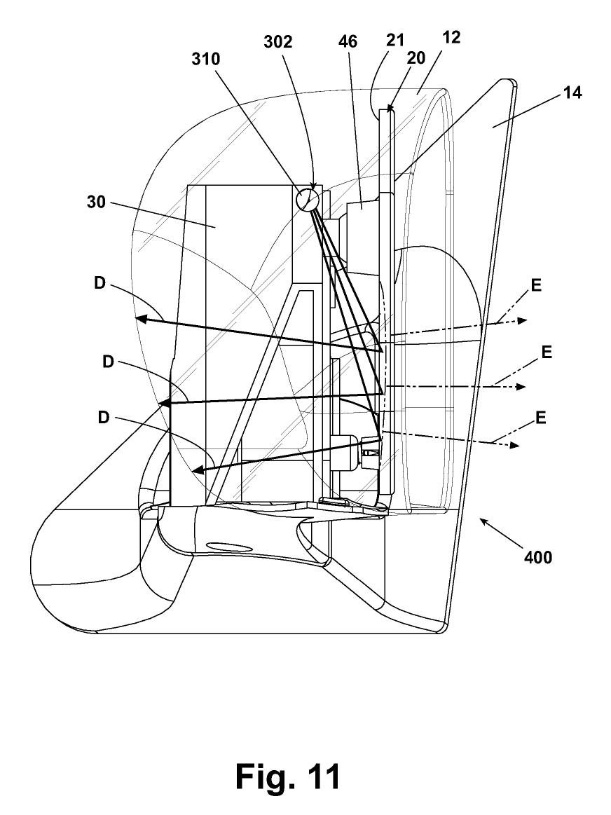

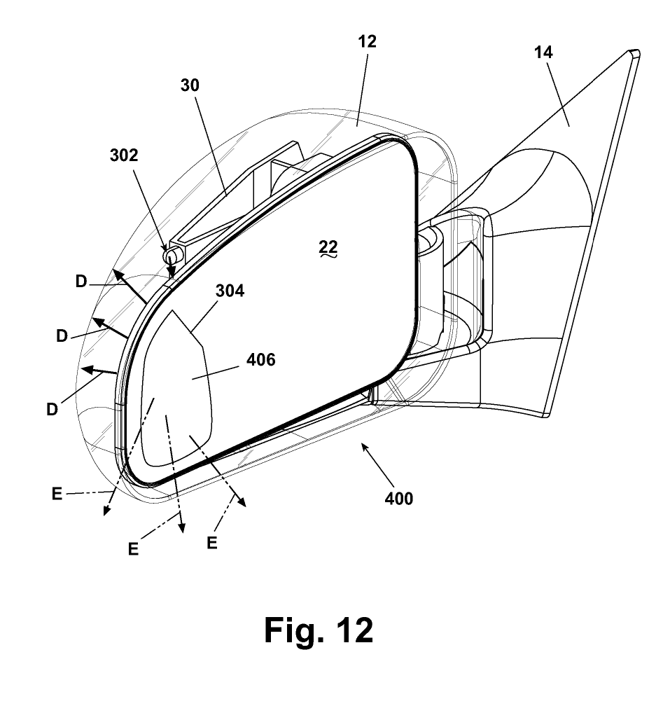

A fifth embodiment of an external mirror system 400 according to the invention is shown in FIGS. 10-12. In this embodiment, the transparent or translucent housing 12 encompasses the bracket 30, and the reflective element carrier 20 mounted thereto, which is pivotable about the pivot mount 46. The housing 12 and the bracket 30 are mounted for rotation to the mirror support 14. A directional light element 302 is mounted to the end of the bracket 30. The forward-facing surface 21 of the reflective element carrier 20 has a defined region 304 with a surface 406 that is partly reflective and partly transmissive inside the region. Preferably the surface 406 will reflect about 90% and transmit about 10% of any light hitting the surface 406. The region 304 can comprise a cut-out in the reflective element carrier 20 with a reflective-transmissive film covering the region to define the reflective/transmissive surface 406, or it can comprise a chromic element 308 disposed between the reflective element carrier 20 and the reflective element 22.

The light element 302 is preferably an incandescent lamp. However, other suitable light sources, such as a light-emitting diode or a light pipe extending from inside the bracket 30, can also be used. The light element 302 is directional in the sense that light emanating from the element is blocked by a shield or mask 310 on or adjacent to the element. The shield 310 is disposed so that light is directed toward the surface 406, where a large portion of it is reflected back through the housing 12 along the arrows D, and a small portion of it is transmitted through the surface 406 on the reflective element 22 along the arrows E. The region 304 can be any shape dependant on the function of the light signal and the amount of reflective surface needed for the reflective element 22.

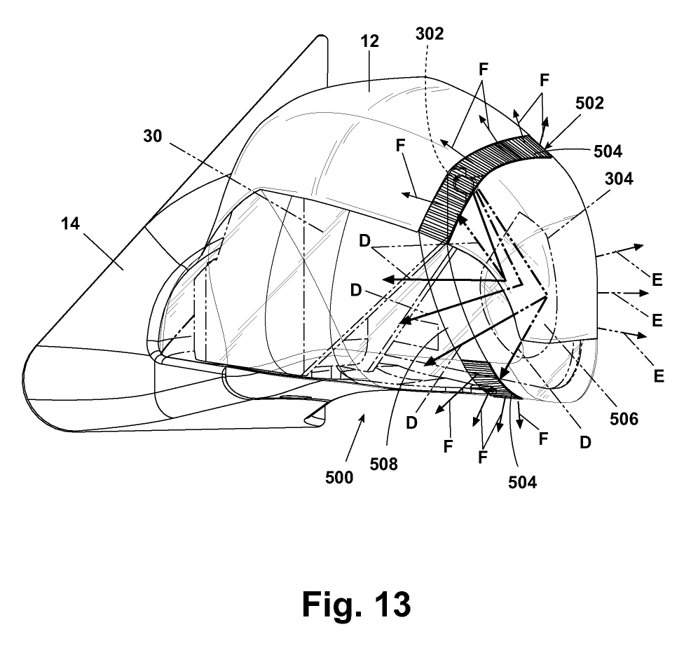

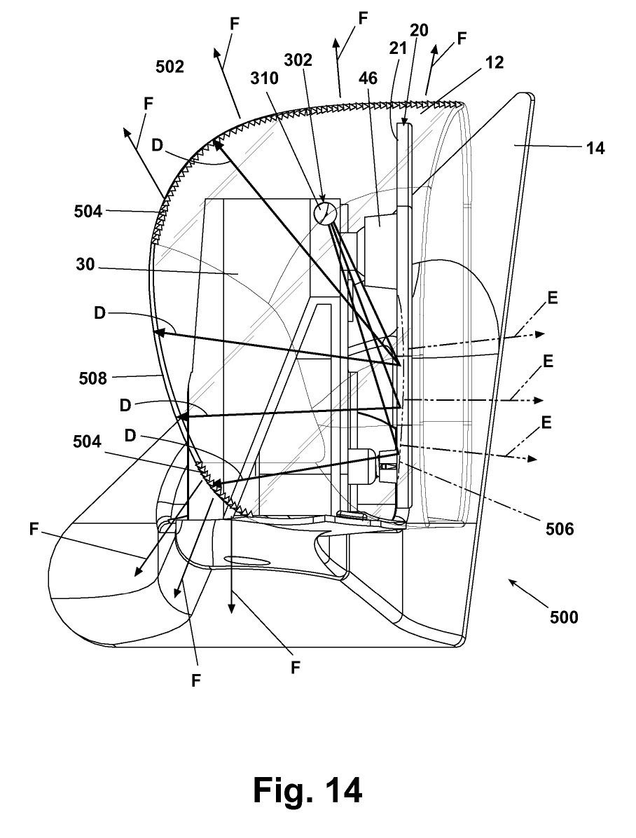

A sixth embodiment of an external mirror system 500 according to the invention is shown in FIGS. 13 and 14. In this embodiment, the transparent or translucent housing 12 encompasses the bracket 30, and the reflective element carrier 20 mounted thereto, which is pivotable about the pivot mount 46. The housing 12 and the bracket 30 are mounted for rotation to the mirror support 14. A directional light element 302 is mounted to the end of the bracket 30. The reflective element carrier 20 has a defined region 304 with a surface 506 that is partly reflective and partly transmissive inside the region 304. Preferably the surface will reflect about 90% and transmit about 10% of any light hitting the surface. The region 304 can comprise a cut-out in the reflective element carrier 20 with a reflective/transmissive film covering the region 304 to define the reflective transmissive surface 506, or it can comprise a chromic element 508 disposed between the reflective element carrier 20 and the reflective element 22, or the region 304 can simply be the forward-facing surface of the reflective element itself using chromic elements already incorporated into the reflective element 22.

The light element 302 is preferably an incandescent lamp. However, other suitable light sources, such as a light-emitting diode or a light pipe extending from inside the bracket 30, can also be used. The light element 302 is directional in the sense that light emanating from the element is blocked by a shield or mask 310 on or adjacent to the element. The shield 310 is disposed so that light is directed toward the surface 506, where a large portion of it is reflected back through the housing 12 along the arrows D and a smaller portion of it is transmitted through the surface 506 and the mirror 22 along arrows E. The region 304 can be any shape dependent on the function of the light signal and the amount of reflective surface needed for the mirror 22.

An optic region 502 is defined on the surface of the housing 12. The optic region 502 has different refraction or transmissibility properties than the remainder of the housing 12. The optic region 502 can also comprise more than one area of refraction or transmissibility as shown in FIG. 13. In FIG. 13, for example, the optic region 502 comprises two bands of collinear lenses 504 separated by a band of clear transparency 508. Preferably, the remainder of the housing 12 is not transparent, but dimly translucent or even opaquely masked. Light reflecting along the paths of the arrows D within the housing 12 is further bent upon reaching the optic region 502. That portion passing through the lenses 504 continues along the arrows F, whereas that portion passing through the transparent band 508 continues along the arrows D.

It will be understood that other embodiments of this invention can be encompassed, especially wherein an interior surface of the mirror housing is provided with optical and/or reflective elements so that light incident thereon from the light element is reflected in a desired direction. In one conceived embodiment, the light from the light element can be reflected downwardly to create a “puddle light” effect (through a transparent or translucent portion of the housing), forward to create a “turn signal” effect, and rearward to create a rearward visual indicator as well. For example, the light illustrated in FIGS. 13-14 can be directed to perform these functions: light represented by the arrows D can be used as a turn signal or other visual indicator in the forward direction, light represented by the arrows E-can be used as a turn signal or other visual indicator in the rearward direction, and light represented by the arrows F can be used as a puddle light in a downward direction.

While the invention has been specifically described in connection with certain specific embodiments thereof, it is to be understood that this is by way of illustration and not of limitation, and the scope of the appended claims should be construed as broadly as the prior art will permit.

1. A vehicular mirror system comprising:
a mirror housing enclosing a mounting bracket having a proximal end and a distal end and adapted to be mounted to a vehicle;
an outwardly-facing reflective element;
a tilt actuator assembly provided with the mounting bracket and mounting the reflective element and comprising an actuator for adjusting the tilt of the reflective element;
a light source mounted within the mirror housing; and
wherein the mirror housing has a translucent portion to transmit light from the light source to the exterior of the mirror housing.

2. The vehicular mirror system of claim 1 wherein the light source comprises at least one incandescent light bulb.

3. The vehicular mirror system of claim 1 wherein the light source comprises at least one light emitting diode.

4. The vehicular mirror system of claim 1 wherein the light source is mounted to the mounting bracket.

5. The vehicular mirror system of claim 1 wherein the light source is mounted to the actuator.

6. The vehicular mirror system of claim 1 wherein the mirror housing comprises at least one optic region having different light transmission properties than the remainder of the mirror housing.

7. The vehicular mirror system of claim 6 and further comprising a light pipe for directing the light from the light source to the at least one optic region.

8. The vehicular mirror system of claim 1 and further comprising a reflective element carrier for supporting the reflective element, wherein the reflective element carrier comprises an area having a reflective surface adapted to reflect light from the light source.

9. The vehicular mirror system of claim 8 wherein the reflective surface is also adapted to transmit a portion of the light from the light source.

10. The vehicular mirror system of claim 9 wherein the area having the reflective surface is adapted to reflect 90% of the light from the light source and transmit 10% of the light from the light source.

11. The vehicular mirror system of claim 1 wherein the light source comprises a directional light element adapted to focus light in a preselected direction.

12. The vehicular mirror system of claim 11 wherein the directional light element is mounted to the distal end of the mounting bracket.

13. A combination motor vehicle and vehicular mirror system comprising:
a motor vehicle;
a mirror housing mounted on the motor vehicle, said mirror housing enclosing a mounting bracket having a proximal end and a distal end;
an outwardly-facing reflective element;
a tilt actuator assembly provided with the mounting bracket and mounting the reflective element and comprising an actuator for adjusting the position of the reflective element;
a light source mounted within the mirror housing; and
wherein the mirror housing has a translucent portion to transmit light from the light source to the exterior of the mirror housing.

14. The combination motor vehicle and vehicular mirror system of claim 13 wherein the light source comprises at least one incandescent light bulb.

15. The combination motor vehicle and vehicular mirror system of claim 13 wherein the light source comprises at least one light emitting diode.

16. The combination motor vehicle and vehicular mirror system of claim 13 wherein the light source is mounted to the mounting bracket.

17. The combination motor vehicle and vehicular mirror system of claim 13 wherein the light source is mounted to the actuator.

18. The combination motor vehicle and vehicular mirror system of claim 13 wherein the mirror housing comprises at least one optic region having different light transmission properties than the remainder of the mirror housing.

19. The combination motor vehicle and vehicular mirror system of claim 18 and further comprising a light pipe for directing the light from the light source to the at least one optic region.

20. The combination motor vehicle and vehicular mirror system of claim 13 and further comprising a reflective element carrier for supporting the reflective element, wherein the reflective element carrier comprises an area having a reflective surface adapted to reflect light from the light source.

21. The combination motor vehicle and vehicular mirror system of claim 20 wherein the reflective surface is also adapted to transmit a portion of the light from the light source.

22. The combination motor vehicle and vehicular mirror system of claim 21 wherein the area having the reflective surface is adapted to reflect 90% of the light from the light source and transmit 10% of the light from the light source.

23. The combination motor vehicle and vehicular mirror system of claim 13 wherein the light source comprises a directional light element adapted to focus light in a preselected direction.

24. The combination motor vehicle and vehicular mirror system of claim 23 wherein the directional light element is mounted to the distal end of the mounting bracket.
